(19) United States
(12) Patent Application Publication
(10) Pub. No.: US 2015/0267103 A1
(43) Pub. Date: Sep. 24, 2015

(54) METHODS FOR SERVICING SUBTERRANEAN WELLS

(71) Applicant: Anatoly Vladimirovich Medvedev, Moscow (RU)

(72) Inventor: Anatoly Vladimirovich Medvedev, Moscow (RU)

(73) Assignee: Schlumberger Technology Corporation, Sugar Land, TX (US)

(21) Appl. No.: 14/414,033

(22) PCT Filed: Jul. 9, 2012
(86) PCT No.: PCT/RU2012/000556

§ 371 Date: May 27, 2015

(51) Int. Cl. C09K 8/42; E21B 33/13

(52) U.S. Cl. CPC C09K 8/426; E21B 33/13; C09K 2208/08

(57) ABSTRACT

Lost circulation in a subterranean well may be controlled by placing into the lost-circulation zone a first fluid comprising a swellable material, followed by a second fluid comprising a plugging material. The swellable material may be oil-swellable, water-swellable or both. The plugging materials may comprise granular materials, lamellar materials, fibers and combinations thereof.

### BACKGROUND

The statements in this section merely provide background information related to the present disclosure and may not constitute prior art.

This disclosure relates to methods for controlling lost circulation in subterranean wells, in particular, fluid compositions and methods for operations during which fluid compositions are pumped into a wellbore, enter voids in the subterranean-well formation through which wellbore fluids escape, and form a seal that limits further egress of wellbore fluid from the wellbore.

During construction of a subterranean well, drilling and cementing operations are performed that involve circulating fluids in and out of the well. The fluids exert hydrostatic and pumping pressure against the subterranean rock formations, and may induce a condition known as lost circulation. Lost circulation is the total or partial loss of drilling fluids or cement slurries into highly permeable zones, cavernous formations and fractures or voids. Such openings may be naturally occurring or induced by pressure exerted during pumping operations. Lost circulation should not be confused with fluid loss, which is a filtration process wherein the liquid phase of a drilling fluid or cement slurry escapes into the formation, leaving the solid components behind.

Lost circulation can be an expensive and time-consuming problem. During drilling, this loss may vary from a gradual lowering of the mud level in the pits to a complete loss of returns. Lost circulation may also pose a safety hazard, leading to well-control problems and environmental incidents. During cementing, lost circulation may severely compromise the quality of the cement job, reducing annular coverage, leaving casing exposed to corrosive downhole fluids, and failing to provide adequate zonal isolation. Lost circulation may also be a problem encountered during well-completion and workover operations, potentially causing formation damage, lost reserves and even loss of the well.

Lost-circulation solutions may be classified into three principal categories: bridging agents, surface-mixed systems and downhole-mixed systems. Bridging agents, also known as lost-circulation materials (LCMs), are solids of various sizes and shapes (e.g., granular, lamellar, fibrous and mixtures thereof). They are generally chosen according to the size of the voids or cracks in the subterranean formation (if known) and, as fluid escapes into the formation, congregate and form a barrier that minimizes or stops further fluid flow. Surface-mixed systems are generally fluids composed of a hydraulic cement slurry or a polymer solution that enters voids in the subterranean formation, sets or thickens, and forms a seal that minimizes or stops further fluid flow. Downhole-mixed systems generally consist of two or more fluids that, upon making contact in the wellbore or the lost-circulation zone, form a viscous plug or a precipitate that seals the zone.

A thorough overview of LCMs, surface-mixed systems and downhole-mixed systems, including guidelines for choosing the appropriate solution for a given situation, is presented in the following reference: Daccord G, Craster B, Ladva H, Jones T G J and Manescu G: “Cement-Formation Interactions,” in Nelson E and Guillot D (eds.): Well Cementing-2^{nd} Edition, Houston: Schlumberger (2006): 202-219.

### SUMMARY

The present disclosure provides means to seal voids and cracks in subterranean-formation rock, thereby minimizing or stopping fluid flow between the formation rock and the wellbore of a subterranean well.

In an aspect, embodiments relate to well-treating compositions comprising a first fluid comprising a swellable material; and a second fluid comprising a plugging material.

In a further aspect, embodiments relate to methods for controlling lost circulation in a subterranean well having one or more lost-circulation zones, comprising preparing a well-treating composition, the composition comprising a first fluid comprising a swellable material, and a second fluid comprising a plugging material; placing the first fluid into the lost-circulation zone; and placing the second fluid into the lost-circulation zone, thereby plugging the lost-circulation zone.

### BRIEF DESCRIPTION OF THE DRAWINGS

FIG. 1 depicts a lost-circulation zone penetrated by a borehole.

FIG. 2 illustrates injection of a first fluid comprising a swellable material, followed by a second fluid comprising a plugging material

FIG. 3 depicts the formation of a plug, from the swellable material, that blocks further egress of fluid from the borehole into the lost circulation zone.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

In an aspect, embodiments relate to well-treating compositions. The present disclosure presents a two-stage fluid system for controlling lost circulation in a subterranean well. The first stage is a fluid that comprises a swellable material. The second stage is a fluid that comprises a plugging material. The first stage enters a lost-circulation zone, followed by the second stage entering the lost-circulation zone and forming a mechanical plug that prevents egress of fluid from the wellbore into the lost-circulation zone. Once the barrier is formed with the means of the second fluid, the swellable particles may expand and form another barrier inside a formation that is resistant to flow.

The swellable material may be oil-swellable or water-swellable or both. Suitable oil-swellable materials include (but would not be limited to) ground rubber, polypropylene, uintaite, uintahite, poly-2, 2, 1-bicyclo heptene (polynorbornene), alkylstyrene, crosslinked substituted vinyl acrylate copolymers, polyisoprene, polyvinyl acetate, polychloroprene, acrylonitrile butadiene, hydrogenated acrylonitrile butadiene, ethylene propylene diene monomer, ethylene propylene monomer, styrene-butadiene, styrene/propylene/diene monomer, brominated poly(isobutylene-co-4-methylstyrene), chlorosulfonated polyethylenes, polyacrylates, polyurethanes, silicones, chlorinated polyethylene, epichlorohydrin ethylene oxide copolymer, ethylene acrylate rubber, ethylene propylene diene terpolymers, sulphonated polyethylene, fluorosilicones, fluoroelastomers and substituted styrene acrylate copolymers. Suitable water-swellable materials include (but would not be limited to) salts of polyacrylic acid, poly(2-hydroxypropyl methacrylate), poly(isobutylene-co-maleic acid), polyacrylamide, poly(ethylene maleic anhydride), crosslinked carboxymethylcellulose, polyvinyl alcohol, crosslinked polyethylene oxide and starch grafted copolymers of polyacrylonitrile.

The particle size of the swellable materials may be between about 1 μm and about 3 mm; it may be between about 10 μm and about 1 mm; it may be between about 100 μm and 0.5 mm. The swellable-material concentration may be between about 1% and about 50% by volume; it may be between about 5% and 40% by volume; it may be between about 10% and 30% by volume. Depending upon the swellable material one chooses, the first fluid may be oil base, water base, an oil-in-water emulsion or a water-in-oil emulsion and mixtures thereof.

Expansion of the swellable material may be minimal until the second fluid enters the lost-circulation zone. Thus, the swellable material may be encapsulated by a coating that degrades or dissolves. The volume ratio between the coating and the swellable material encapsulated within (coating:substrate) may vary between about 5:95 and 80:20, preferably between about 10:90 and 50:50. The capsule coating may comprise polyvinylalcohol, partially saponified polyvinylalcohol, polyvinylpyrrolidone, methylcellulose, cellulose acetate, carboxymethylcelluose, hydroxyethylcellulose, polyethylene oxide or gelatin, substituted and unsubstituted lactide, glycolide, polylactic acid, polyglycolic acid, copolymers of polylactic acid and polyglycol is acid, copolymers of glycolic acid with other hydroxy-, carboxylic acid-, or hydroxycarboxyl is acid-containing moieties, and copolymers of lactic acid with other hydroxy-, carboxylic acid-, or hydroxycarboxylic acid-containing moieties, and mixtures thereof. A trigger for releasing the encapsulated material may include (but would not be limited to) passage of the process fluid through the nozzles of a drill bit before the process fluid enters the lost circulation zone. The resulting shear may rupture the capsules. such as

Suitable plugging materials include (but would not be limited to) granular particles, lamellar particles, fibers and combinations thereof. Example plugging materials include (but would not be limited to) nut shells, plastic particles, limestone particles, calcium carbonate particles, silica particles, silica fibers, polymer fibers, sulfur particles, perlite particles, cellophane flakes, sawdust, prairie hay, tree bark, cottonseed hulls, shredded wood, cellulose fibers, encapsulated bentonite and combinations thereof.

As known in the art, the nature and size of the plugging material may be chosen according to the size of the opening from the wellbore into the lost-circulation zone. In the context of the present disclosure, the particle size of the granular particles may be between about 1 μm and about 8 mm. As is also known in the art, the plugging efficiency may be enhanced by selecting a multimodal particle-size distribution comprising small, medium and large particles. The medium-size particles may be about one order of magnitude larger than the small particles, and the large particles may be about one order of magnitude larger than the medium-size particles.

For fibrous materials, the fiber length may be between about 1 mm and about 20 mm; it may be between about 5 mm and about 10 mm. Mixture of fibers might be used as well. Fibers may evolve downhole depending on the conditions and for example become adhesive with temperature, such phenomena are for example disclosed in U.S.2010/0152070, WO2010142370 and/or EP2085447 all incorporated herein by reference. The plugging material concentration may be between about 30 kg/m³ and about 1500 kg/m³.

In another aspect, embodiments relate to methods for controlling lost circulation in a subterranean well having one or more lost-circulation zones. A well-treating composition as described herein above, the composition comprising a first fluid comprising a swellable material, and a second fluid comprising a plugging material. The first fluid is placed into the lost-circulation zone, followed by the second fluid, thereby plugging the lost-circulation zone.

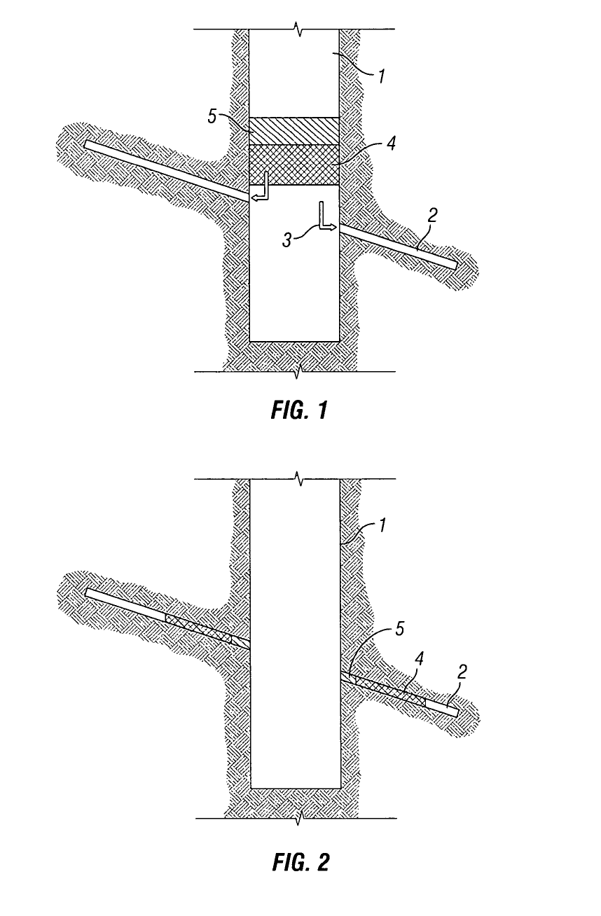

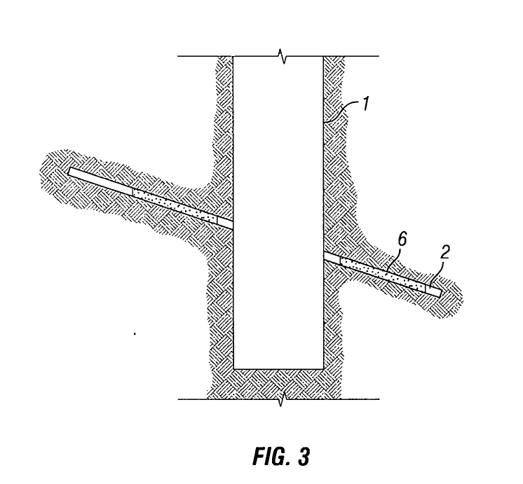

The disclosed methods for controlling lost circulation may be illustrated by FIGS. 1-3. FIG. 1 shows a typical lost-circulation scenario, wherein a borehole 1 penetrates a lost-circulation zone 2, thereby allowing a process fluid 3 (e.g., drilling fluid) to flow from the borehole into the lost-circulation zone. The disclosed well-treating composition comprises a first fluid comprising swellable materials 4 followed by a second fluid comprising plugging materials 5. FIG. 2 depicts the entrance of the first fluid into the lost circulation zone, followed by the second fluid. Those skilled in the art will recognize that the first and second fluids do not necessarily have to be in two connected stages. Process fluid or a spacer fluid may separate them. After the second fluid has entered the lost-circulation zone, the first and second fluids have formed a barrier 6 that blocks further egress of process fluid from the wellbore. Without wishing to be bound by any theory, the authors have determined that both fluid have a synergistic effect as in fact the first fluid if used alone may not sole the lost circulation problem as this would require static conditions; but the second fluid pumped alone would also not solve the lost circulation as accurately as this would plug the voids and/or cavern at the “mouth” of the formation and thus form a plug that would be highly sensible to mechanical constraint such as pipe and/or casing movement. The second fluid, when used in connection with the first one, enable the creation of condition close to static thus allowing operators to solve efficiently the lost circulation problem.

### EXAMPLES

The following examples serve to further illustrate the present disclosure.

All of the following examples made use of an apparatus to simulate a lost-circulation zone. The apparatus consisted of a solid stainless steel cylinder through which a slot had been machined out. The slot dimensions were 4 mm wide, 46 mm long and 50 mm deep. The test method consisted of pumping the first fluid alone in examples 1 and 2; Examples 3 and 4 involve both the first and second fluids into the slot, allowing the mixture to set for a period of time and form a plug, and then subjecting the slot to water pressure. The pressure at which the plug failed was measured.

### Example 1

2.75 of Hyperseal DP-2010N water swellable rubber (available from Hyperseal, Inc., Palm Desert, Calif., USA) was mixed with 11.36 g of an oil-base drilling fluid (Versaclean 70/30 available from MI-SWACO). The mixture was then placed in the slot and allowed to cure for 3 days at ambient temperature. After the curing period, the slot was placed in a fluid-loss cell and pressure was applied. The plug failed at 69 kPa (10 psi) pressure.

### Example 2

2.15 g of Hyperseal DP-2010N water swellable rubber were modified by gluing 2.43 g of Mikhart 0.5/1 calcium carbonate particles (average particle size: 1147 μm) (available from Provencale, S.A. Brignoles, France). The composite was mixed with 9.91 g of oil-base drilling fluid and placed into the slot for 3 days at ambient temperature. After the curing period, the slot was placed in a fluid-loss cell and pressure was applied. The plug failed at 69 kPa (10 psi) pressure.

### Example 3

2.55 g of Hypersel DP-2010N water swellable rubber were mixed with 10.95 g of oil-base drilling fluid and 0.21 g of polyamide fibers (12 mm length, 50 μm diameter) and placed in the slot for 3 days at ambient temperature. After the curing period, the slot was placed in a fluid-loss cell and pressure was applied. The plug failed at 210 kPa (30 psi) pressure.

### Example 4

2.54 g of ethylene propylene diene monomer (EPDM) rubber were mixed with 11.0 g of oil-base drilling fluid and 0.21 g of polyamide fibers (12 mm length, 50 μm diameter) and placed in the slot for 3 days at ambient temperature. After the curing period, the slot was placed in a fluid-loss cell and pressure was applied. The plug failed at 345 kPa (50 psi) pressure.

1. A well-treating composition, comprising:
(i) a first fluid comprising a swellable material; and
(ii) a second fluid comprising a plugging material.

2. The composition of claim 1, wherein the swellable material comprises ground rubber, polypropylene, uintaite, uintahite, poly-2, 2, 1-bicyclo heptene (polynorbornene), alkylstyrene, crosslinked substituted vinyl acrylate copolymers, polyisoprene, polyvinyl acetate, polychloroprene, acrylonitrile butadiene, hydrogenated acrylonitrile butadiene, ethylene propylene diene monomer, ethylene propylene monomer, styrene-butadiene, styrene/propylene/diene monomer, brominated poly(isobutylene-co-4-methylstyrene), chlorosulfonated polyethylenes, polyacrylates, polyurethanes, silicones, chlorinated polyethylene, epichlorohydrin ethylene oxide copolymer, ethylene acrylate rubber, ethylene propylene diene terpolymers, sulphonated polyethylene, fluorosilicones, fluoroelastomer, substituted styrene acrylate copolymers, salts of polyacrylic acid, poly(2-hydroxypropyl methacrylate), poly(isobutylene-co-maleic acid), polyacrylamide, poly(ethylene maleic anhydride), crosslinked carboxymethylcellulose, polyvinyl alcohol, crosslinked polyethylene oxide, starch grafted copolymer of polyacrylonitrile, and mixtures thereof.

3. The composition of claim 1, wherein the particle size of the swellable material is between about 1 μm and about 3 mm.

4. The composition of claim 1, wherein the swellable-material concentration is between about 1% and about 50% by volume of the composition.

5. The composition of claim 1, wherein the first fluid is oil base.

6. The composition of claim 1, wherein the first fluid is water base.

7. The composition of claim 1, wherein the first fluid is an oil-in-water emulsion.

8. The composition of claim 1, wherein the first fluid is a water-in-oil emulsion.

9. The composition of claim 1, wherein the plugging material comprises granular particles, lamellar particles, fibers and combinations thereof.

10. The composition of claim 9, wherein the particle size of the granular particles is between about 1 μm and about 8000 μm.

11. The composition of claim 1, wherein the plugging material comprises nut shells, plastic particles, limestone particles, calcium carbonate particles, silica particles, silica fibers, polymer fibers, sulfur particles, perlite particles, cellophane flakes, sawdust, prairie hay, tree bark, cottonseed hulls, shredded wood, encapsulated bentonite and combinations thereof.

12. The composition of claim 1, wherein the plugging-material concentration is between about 30 and about 1500 kg/m³.

13. A method for controlling lost circulation in a subterranean well having one or more lost-circulation zones, comprising:
(i) preparing a well-treating composition, the composition comprising a first fluid comprising a swellable material, and a second fluid comprising a plugging material;
(ii) placing the first fluid into the lost-circulation zone; and
(iii) placing the second fluid into the lost-circulation zone, thereby plugging the lost-circulation zone.

14. The method of claim 13, wherein the swellable material comprises ground rubber, polypropylene, uintaite, uintahite, poly-2, 2, 1-bicyclo heptene (polynorbornene), alkylstyrene, crosslinked substituted vinyl acrylate copolymers, polyisoprene, polyvinyl acetate, polychloroprene, acrylonitrile butadiene, hydrogenated acrylonitrile butadiene, ethylene propylene diene monomer, ethylene propylene monomer, styrene-butadiene, styrene/propylene/diene monomer, brominated poly(isobutylene-co-4-methylstyrene), chlorosulfonated polyethylenes, polyacrylates, polyurethanes, silicones, chlorinated polyethylene, epichlorohydrin ethylene oxide copolymer, ethylene acrylate rubber, ethylene propylene diene terpolymers, sulphonated polyethylene, fluorosilicones, fluoroelastomer, substituted styrene acrylate copolymers, salts of polyacrylic acid, poly(2-hydroxypropyl methacrylate), poly(isobutylene-co-maleic acid), polyacrylamide, poly(ethylene maleic anhydride), crosslinked carboxymethylcellulose, polyvinyl alcohol, crosslinked polyethylene oxide, starch grafted copolymer of polyacrylonitrile, and mixtures thereof.

15. The method of claim 13, wherein the particle size of the swellable material is between about 1 μm and about 3 mm.

16. The method of claim 13, wherein the swellable-material concentration is between about 1% and about 50% by volume of the composition.

17. The method of claim 13, wherein the first fluid is oil base.

18. The method of claim 13, wherein the first fluid is water base.

19. The method of claim 13, wherein the first fluid is an oil-in-water emulsion.

20. The method of claim 13, wherein the first fluid is a water-in-oil emulsion.

21. The method of claim 13, wherein the plugging material comprises granular particles, lamellar particles, fibers and combinations thereof.

22. The method of claim 21, wherein the particle size of the granular particles is between about 1 μm and about 8000 μm.

23. The method of claim 13, wherein the plugging material comprises nut shells, plastic particles, limestone particles, calcium carbonate particles, silica particles, silica fibers, polymer fibers, sulfur particles, perlite particles, cellophane flakes, sawdust, prairie hay, tree bark, cottonseed hulls, shredded wood, encapsulated bentonite and combinations thereof.

24. The method of claim 13, wherein the plugging-material concentration is between about 30 and about 1500 kg/m³.

25. The method of claim 13, wherein the swelling material is encapsulated.
